(19) United States
(12) Patent Application Publication
(10) Pub. No.: US 2025/0102992 A1
(43) Pub. Date: Mar. 27, 2025

(54) IMAGE FORMING APPARATUS

(71) Applicant: FUJIFILM Business Innovation Corp., Tokyo (JP)

(72) Inventor: Kazuyoshi Hagiwara, Kanagawa (JP)

(73) Assignee: FUJIFILM Business Innovation Corp., Tokyo (JP)

(21) Appl. No.: 18/438,085

(22) Filed: Feb. 9, 2024

(30) Foreign Application Priority Data
Sep. 21, 2023 (JP) 2023-156397

(51) Int. Cl. G03G 21/10; G03G 15/00; G03G 21/12

(52) U.S. Cl. CPC G03G 21/105; G03G 15/50; G03G 21/12; G03G 2215/0805

(57) ABSTRACT

An image forming apparatus includes: an image holding member that moves while holding an image to be transferred to a recording medium; a cleaning member that moves in contact with the image holding member to clean the image holding member; a conveyance member that conveys powder removed from the image holding member by the cleaning member; and a processor configured to perform control to cause conveyance of powder by the conveyance member to be performed in a state where the image holding member is stopped or in a state where a moving speed of the image holding member is reduced.

### CROSS-REFERENCE TO RELATED APPLICATIONS

This application is based on and claims priority under 35 USC 119 from Japanese Patent Application No. 2023-156397 filed Sep. 21, 2023.

### BACKGROUND

### (i) Technical Field

The present disclosure relates to an image forming apparatus.

### (ii) Related Art

Japanese Unexamined Patent Application Publication No. 2014-21388 discloses a configuration including a first image forming section that forms an image using toner having a first particle diameter, a second image forming section that forms an image using second toner having a particle diameter larger than the first particle diameter, and a conveyance path along which the toner collected from the first image forming section and the second image forming section is conveyed.

Japanese Unexamined Patent Application Publication No. 2007-219372 discloses a configuration in which collected toner from an image carrier cleaning device and collected toner from an intermediate transfer body cleaning device are introduced into a relay conveyance member from different directions and are accommodated in a collected toner accommodating section via the relay conveyance member.

Japanese Unexamined Patent Application Publication No. 2010-217413 discloses a configuration including a static elimination member that is disposed to be in contact with a blade of a conveyance member and eliminates static electricity of a developer by coming into contact with the developer adhering to the blade.

### SUMMARY

An image forming apparatus may be provided with an image holding member that moves while holding a formed image, a cleaning member that cleans the image holding member, and a conveyance member that conveys powder removed from the image holding member by the cleaning member.

If the conveyance of powder by the conveyance member is stopped in response to stop of the cleaning member or the image holding member, a situation may occur in which the conveyance of powder is not performed although powder to be conveyed exists.

Aspects of non-limiting embodiments of the present disclosure relate to increasing a conveyance amount of powder removed from an image holding member by a cleaning member as compared with a configuration in which conveyance of powder by a conveyance member is stopped in response to stop of the cleaning member or the image holding member.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an image forming apparatus including: an image holding member that moves while holding an image to be transferred to a recording medium; a cleaning member that moves in contact with the image holding member to clean the image holding member; a conveyance member that conveys powder removed from the image holding member by the cleaning member; and a processor configured to perform control to cause conveyance of powder by the powder conveyance member to be performed in a state where the cleaning member is stopped or in a state where an output of the cleaning member is reduced.

### BRIEF DESCRIPTION OF THE DRAWINGS

An exemplary embodiment of the present disclosure will be described in detail based on the following figures, wherein:

FIG. 1 is a diagram illustrating an image forming apparatus;

FIG. 2 is a diagram illustrating an example of a hardware configuration of a control section;

FIG. 3 is a cross-sectional diagram of a belt cleaner when viewed from a back side of the image forming apparatus;

FIG. 4 is a diagram illustrating one state of the belt cleaner;

FIG. 5 is a diagram illustrating another state of the belt cleaner; and

FIGS. 6A to 6C are diagrams illustrating a configuration of a drive mechanism.

### DETAILED DESCRIPTION

In the following, an exemplary embodiment of the present disclosure will be described in detail with reference to the accompanying drawings.

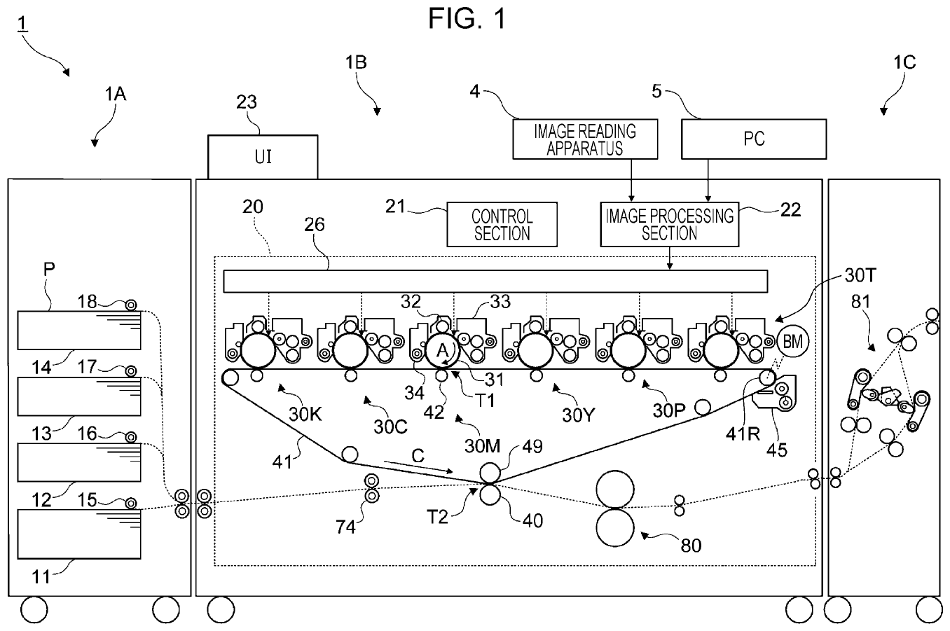

FIG. 1 is a diagram illustrating an image forming apparatus 1.

The image forming apparatus 1 according to the present exemplary embodiment includes a sheet feeding unit 1A, a printing unit 1B, and a sheet discharge unit 1C.

The sheet feeding unit 1A includes a first sheet accommodating section 11 to a fourth sheet accommodating section 14 that accommodate sheets P as an example of a recording medium.

In addition, the sheet feeding unit 1A is provided with feed rolls 15 to 18 that are provided for the first sheet accommodating section 11 to the fourth sheet accommodating section 14, respectively, and that feed the sheet P accommodated in each sheet accommodating section to a conveyance path coupled to the printing unit 1B.

The printing unit 1B includes an image forming section 20 that forms an image on the sheet P. In addition, the printing unit 1B is provided with a control section 21 that controls each section of the image forming apparatus 1.

The printing unit 1B further includes an image processing section 22. The image processing section 22 performs image processing on image data transmitted from an image reading apparatus 4 or a personal computer (PC) 5.

Furthermore, the printing unit 1B is provided with a user interface (UI) 23 including a touch panel or the like, notifies a user of information, and receives input of information from the user.

The image forming section 20 as an example of an image forming device is provided with six image forming units 30T, 30P, 30Y, 30M, 30C, and 30K (hereinafter, may be simply referred to as “image forming units 30”) disposed in parallel at regular intervals.

Each image forming unit 30 includes a photoreceptor drum 31 on which an electrostatic latent image is formed while rotating in a direction of an arrow A, a charging roll 32 that charges a surface of the photoreceptor drum 31, a developing device 33 that develops the electrostatic latent image formed on the photoreceptor drum 31, and a drum cleaner 34 that removes toner or the like from the surface of the photoreceptor drum 31.

Further, the image forming section 20 is provided with an exposure apparatus 26 that exposes the photoreceptor drum 31 of each image forming unit 30 to laser light.

The exposure of the photoreceptor drum 31 by the exposure apparatus 26 is not limited to the use of the laser light. For example, a light source such as a light emitting diode (LED) may be provided for each image forming unit 30, and the exposure of the photoreceptor drum 31 may performed using light emitted from the light source.

Each image forming unit 30 has the same configuration except for the toner stored in the developing device 33. The image forming units 30Y, 30M, 30C, and 30K form yellow (Y), magenta (M), cyan (C), and black (K) toner images, respectively.

The image forming units 30T and 30P form toner images using toner corresponding to a corporate color, foaming toner for Braille, fluorescent color toner, toner for improving glossiness, or the like. In other words, the image forming units 30T and 30P form toner images using special color toner.

Furthermore, the image forming section 20 is provided with an intermediate transfer belt 41 to which the toner images in the respective colors formed on the photoreceptor drums 31 of the respective image forming units 30 are transferred.

In addition, the image forming section 20 is provided with primary transfer rolls 42 each of which transfers the color toner image of the corresponding image forming unit 30 to the intermediate transfer belt 41 at a primary transfer section T1.

The image forming section 20 is provided with a secondary transfer roll 40 with which the toner images transferred to the intermediate transfer belt 41 are collectively transferred to the sheet P at a secondary transfer section T2.

Furthermore, the image forming section 20 is provided with a belt cleaner 45 that removes toner or the like on the surface of the intermediate transfer belt 41, and a fixing device 80 that fixes the secondarily transferred image onto the sheet P.

The image forming section 20 performs an image forming operation based on a control signal from the control section 21.

Specifically, in the image forming section 20, first, the image processing section 22 performs image processing on image data input from the image reading apparatus 4 or the PC 5, and the image data subjected to the image processing is supplied to the exposure apparatus 26.

Then, for example, in the magenta (M) image forming unit 30M, a surface of the photoreceptor drum 31 is charged by the charging roll 32, and then the photoreceptor drum 31 is irradiated with laser light modulated with the image data obtained from the image processing section 22 by the exposure apparatus 26.

Thus, an electrostatic latent image is formed on the photoreceptor drum 31.

The formed electrostatic latent image is developed by the developing device 33, and a magenta toner image is formed on the photoreceptor drum 31.

Similarly, yellow, cyan, and black toner images are formed in the image forming unit 30Y, 30C, and 30K, and toner images in special colors are formed in the image forming units 30T and 30P.

The toner images of the respective colors formed by the image forming units 30 are sequentially electrostatically transferred by the primary transfer rolls 42 onto the intermediate transfer belt 41 rotating in a direction of an arrow C in FIG. 1, and superimposed toner images are formed on the intermediate transfer belt 41.

The superimposed toner images formed on the intermediate transfer belt 41 are conveyed to the secondary transfer section T2 constituted by the secondary transfer roll 40 and a backup roll 49 with the movement of the intermediate transfer belt 41.

On the other hand, the sheet P is, for example, picked up from the first sheet accommodating section 11 by the feed roll 15, and then conveyed to a position of a registration roll 74 via the conveyance path.

When the superimposed toner images are conveyed to the secondary transfer section T2, the sheet P is supplied from the registration roll 74 to the secondary transfer section T2 in accordance with the timing.

Then, in the secondary transfer section T2, the superimposed toner images are collectively electrostatically transferred onto the sheet P by the action of a transfer electric field formed between the secondary transfer roll 40 and the backup roll 49.

Thereafter, the sheet P on which the superimposed toner images have been electrostatically transferred is conveyed to the fixing device 80.

In the fixing device 80, the sheet P on which an unfixed toner image is formed is pressed and heated, such that fixing processing of the toner image onto the sheet P is performed.

Then, the sheet P on which the fixing processing has been performed is conveyed to a sheet stacking section (not illustrated) after passing through a curl correction section 81 provided in the sheet discharge unit 1C.

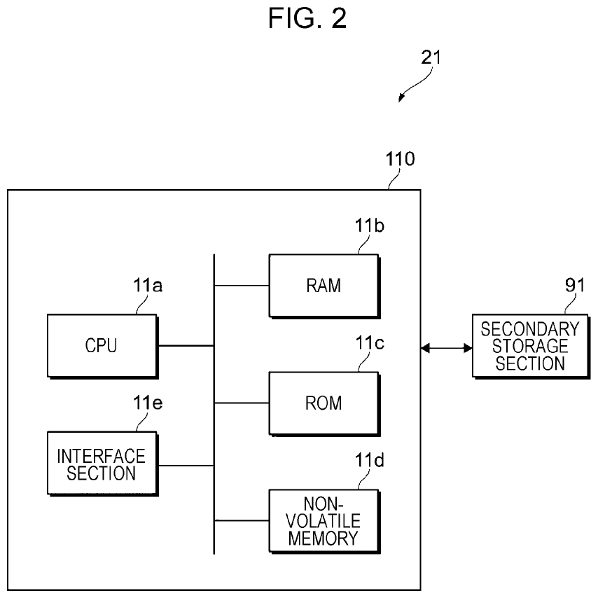

FIG. 2 is a diagram illustrating an example of a hardware configuration of the control section 21. The control section 21 is implemented by a computer.

The control section 21 includes an arithmetic processing section 110 that executes digital arithmetic processing in accordance with a program, and a secondary storage section 91 that stores information.

The secondary storage section 91 is implemented by an existing information storage apparatus, for example, a hard disk drive (HDD), a semiconductor memory, or a magnetic tape.

The arithmetic processing section 110 is provided with a central processing unit (CPU) 11a as an example of a processor.

In addition, the arithmetic processing section 110 is provided with a random access memory (RAM) 11b used as a working memory or the like of the CPU 11a, and a read-only memory (ROM) 11c in which a program or the like executed by the CPU 11a is stored.

In addition, the arithmetic processing section 110 is provided with a non-volatile memory 11d that is configured to be rewritable and can hold data even when power supply is stopped.

The non-volatile memory 11d may include, for example, a static RAM (SRAM), a flash memory, or the like backed up by a battery. The secondary storage section 91 stores various types of information such as a program to be executed by the arithmetic processing section 110.

In the present exemplary embodiment, the CPU 11a of the arithmetic processing section 110 reads a program stored in the ROM 11c or the secondary storage section 91 to execute various types of processing performed in the image forming apparatus 1.

The program to be executed by the CPU 11a may be provided to the image forming apparatus 1 in a state of being stored in a computer-readable recording medium such as a magnetic recording medium (such as a magnetic tape or a magnetic disk), an optical recording medium (such as an optical disc), a magneto-optical recording medium, or a semiconductor memory. Furthermore, the program to be executed by the CPU 11a may be provided to the image forming apparatus 1 by using a communication medium such as the Internet.

As used herein, the processor refers to a processor in a broad sense, and includes a general-purpose processor (for example, CPU: Central Processing Unit, or the like) and a dedicated processor (for example, GPU: Graphics Processing Unit, ASIC: Application Specific Integrated Circuit, FPGA: Field Programmable Gate Array, programmable logic devices, or the like).

Further, the operation of the processor may be performed not only by one processor but also by a plurality of processors existing at physically distant positions in cooperation with each other. Furthermore, the order of the operations of the processor is not limited to only the order described in the present exemplary embodiment and may be changed.

### Configuration of Belt Cleaner 45

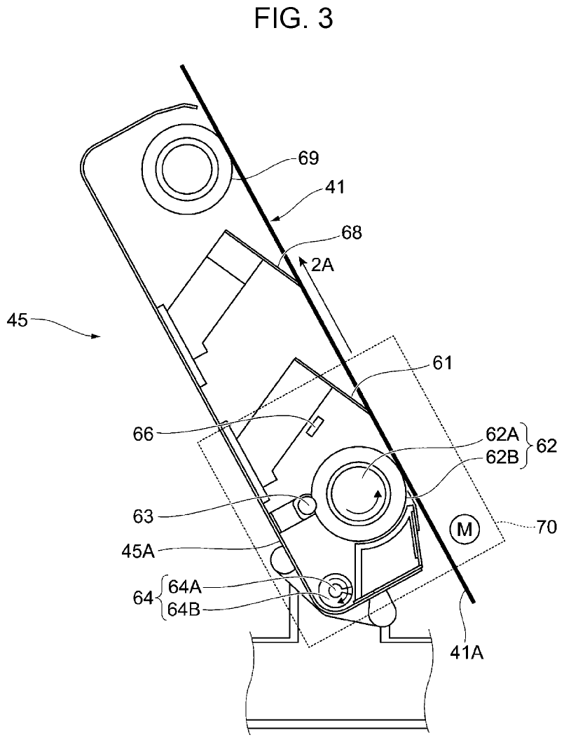

FIG. 3 is a cross-sectional diagram of the belt cleaner 45 when viewed from a back side of the image forming apparatus 1.

In the present exemplary embodiment, the belt cleaner 45 is provided at a position facing an outer peripheral surface 41A of the intermediate transfer belt 41.

At the portion facing the belt cleaner 45, the intermediate transfer belt 41 moves in one direction 2A, which is an upper left direction in the drawing.

The belt cleaner 45 is provided with a powder accommodating section 45A as an example of an accommodating section that accommodates powder.

The belt cleaner 45 removes, from the outer peripheral surface 41A of the intermediate transfer belt 41, which is an example of an image holding member, powder such as toner or paper dust adhering to the outer peripheral surface 41A.

The powder removed by the belt cleaner 45 is temporarily accommodated in the box-shaped powder accommodating section 45A provided in the belt cleaner 45.

A downstream cleaning member 61 that cleans the intermediate transfer belt 41 is provided in the powder accommodating section 45A.

The intermediate transfer belt 41 is a moving body that moves while holding the above-described toner image as an example of an image to be transferred to the sheet P (see FIG. 1). The intermediate transfer belt 41 moves in a state of holding the toner images in the respective colors formed by the respective image forming units 30 (see FIG. 1).

With the movement of the intermediate transfer belt 41, the toner images held by the intermediate transfer belt 41 are conveyed to the secondary transfer section T2 (see FIG. 1) and are transferred onto the sheet P at the secondary transfer section T2.

The downstream cleaning member 61 is disposed downstream of the secondary transfer section T2 (see FIG. 1) in a movement direction of the intermediate transfer belt 41.

The downstream cleaning member 61 comes into contact with a portion of the intermediate transfer belt 41 positioned downstream of the secondary transfer section T2 to clean the outer peripheral surface 41A of the intermediate transfer belt 41.

The downstream cleaning member 61 is constituted by a plate-like member. Furthermore, the downstream cleaning member 61 is made of rubber and has elasticity.

The downstream cleaning member 61 is disposed in contact with the intermediate transfer belt 41 moving in the one direction 2A, and cleans the intermediate transfer belt 41. More specifically, the downstream cleaning member 61 is disposed in contact with the outer peripheral surface 41A of the intermediate transfer belt 41, and scrapes off and removes powder such as toner or paper dust adhering to the outer peripheral surface 41A.

The downstream cleaning member 61 is disposed at an angle with respect to the movement direction of the intermediate transfer belt 41. The downstream cleaning member 61 is provided so as to be gradually separated from the intermediate transfer belt 41 toward the downstream side of the intermediate transfer belt 41 in the movement direction.

Furthermore, in the present exemplary embodiment, an upstream cleaning member 62 disposed in contact with the outer peripheral surface 41A of the intermediate transfer belt 41 is provided upstream of the downstream cleaning member 61 in the movement direction of the intermediate transfer belt 41.

The upstream cleaning member 62 is provided in the powder accommodating section 45A. The upstream cleaning member 62 is disposed below the downstream cleaning member 61.

The upstream cleaning member 62 moves in contact with the outer peripheral surface 41A of the intermediate transfer belt 41 and cleans the intermediate transfer belt 41.

More specifically, the upstream cleaning member 62 is a rotating member that rotates. The upstream cleaning member 62 rotates in a counterclockwise direction in the drawing while maintaining a state in contact with the outer peripheral surface 41A of the intermediate transfer belt 41. Thus, the intermediate transfer belt 41 is cleaned by the upstream cleaning member 62.

The upstream cleaning member 62 is provided with a rotation shaft 62A rotated by a motor (described later) and a brush-shaped cleaning section 62B provided around the rotation shaft 62A.

In the present exemplary embodiment, the cleaning section 62B comes into contact with the outer peripheral surface 41A of the intermediate transfer belt 41, thereby removing powder adhering to the outer peripheral surface 41A of the intermediate transfer belt 41.

In the present exemplary embodiment, a circumferential speed of the upstream cleaning member 62 is higher than a moving speed of the intermediate transfer belt 41.

The circumferential speed of the upstream cleaning member 62 is not limited to this, and may be lower than the moving speed of the intermediate transfer belt 41.

Furthermore, in the present exemplary embodiment, the rotation direction of the upstream cleaning member 62 is a counterclockwise direction.

In this case, at a contact portion where the upstream cleaning member 62 and the intermediate transfer belt 41 come into contact with each other, a contact portion of the upstream cleaning member 62 coming into contact with the intermediate transfer belt 41 and the intermediate transfer belt 41 move in the same direction.

The rotation direction of the upstream cleaning member 62 is not limited to the counterclockwise direction, and may be a clockwise direction.

Inside the powder accommodating section 45A, a contact portion 63 with which the cleaning section 62B of the upstream cleaning member 62 comes into contact is further provided.

In the present exemplary embodiment, a configuration is adopted in which powder adhering to the cleaning section 62B of the upstream cleaning member 62 is removed from the cleaning section 62B by the contact portion 63.

The powder removed by the contact portion 63 moves downward.

Note that powder removed from the intermediate transfer belt 41 by the downstream cleaning member 61 also moves downward via the upstream cleaning member 62 and the contact portion 63 positioned below the downstream cleaning member 61.

Below the upstream cleaning member 62 and the contact portion 63, a powder conveyance member 64 as an example of a conveyance member that conveys powder is provided.

The powder conveyance member 64 is provided in the powder accommodating section 45A.

The powder removed from the intermediate transfer belt 41 by the downstream cleaning member 61 and the powder removed from the intermediate transfer belt 41 by the upstream cleaning member 62 are conveyed by the powder conveyance member 64. The powder conveyance member 64 conveys the powder to a powder accommodating container (not illustrated) positioned outside the powder accommodating section 45A.

The powder conveyance member 64 is provided along a direction orthogonal to a sheet surface of FIG. 3. In other words, the powder conveyance member 64 extends in a direction orthogonal to the movement direction of the intermediate transfer belt 41.

The direction orthogonal to the movement direction of the intermediate transfer belt 41 is also a width direction of the intermediate transfer belt 41, and the powder conveyance member 64 extends in the width direction of the intermediate transfer belt 41.

Note that although the description is omitted above, the downstream cleaning member 61 and the upstream cleaning member 62 are also provided along the direction orthogonal to the sheet surface of FIG. 3, and extend in the width direction of the intermediate transfer belt 41.

The powder conveyance member 64 includes a rotation shaft 64A that rotates by receiving a driving force from a motor (described later), and a protruding portion 64B that protrudes from an outer peripheral surface of the rotation shaft 64A.

The protruding portion 64B is provided around the rotation shaft 62A and is provided in a spiral shape. In other words, the protruding portion 64B is provided around the rotation shaft 62A and is provided in a screw shape.

In the present exemplary embodiment, when the powder conveyance member 64 rotates, powder moves in an axial direction of the powder conveyance member 64 by the spiral protruding portion 64B.

As a result, powder is conveyed by the powder conveyance member 64, and powder in the powder accommodating section 45A moves to the powder accommodating container (not illustrated).

Further, in the present exemplary embodiment, an amount detection sensor 66 for detecting an amount of powder in the powder accommodating section 45A is provided in the powder accommodating section 45A.

Further, in the present exemplary embodiment, a drive mechanism 70 that drives the powder conveyance member 64 and the upstream cleaning member 62 is provided. The drive mechanism 70 is disposed further to the back side than the belt cleaner 45 in a direction orthogonal to the sheet surface of FIG. 3.

Furthermore, in the present exemplary embodiment, a contact member 68 and a contact member 69 that come into contact with the outer peripheral surface 41A of the intermediate transfer belt 41 are provided downstream of the downstream cleaning member 61 in the movement direction of the intermediate transfer belt 41.

### Drive Control of Upstream Cleaning Member 62 and Powder Conveyance Member 64

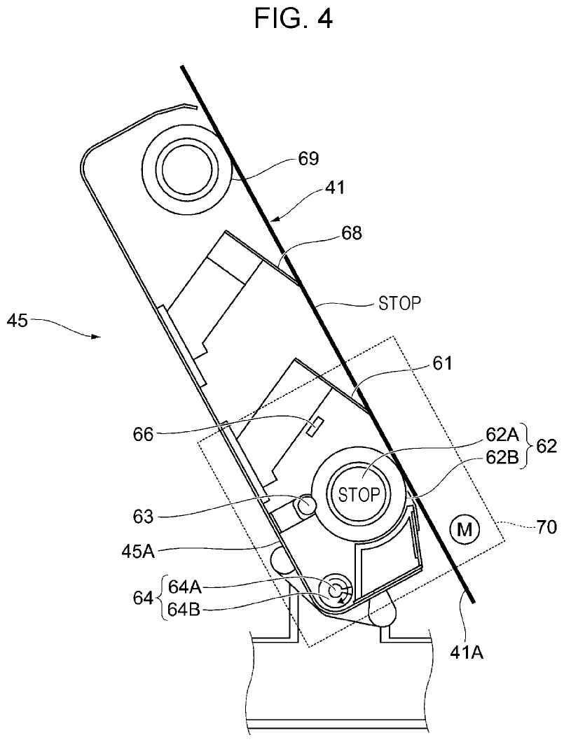

FIG. 4 is a diagram illustrating one state of the belt cleaner 45.

In the present exemplary embodiment, control is performed such that the conveyance of powder by the powder conveyance member 64 is performed in a state where the upstream cleaning member 62 is stopped.

In the present exemplary embodiment, the CPU 11a as an example of a processor controls each section of the image forming apparatus 1. In the control, the CPU 11a performs control to cause the conveyance of powder by the powder conveyance member 64 to be performed in a state where rotation of the upstream cleaning member 62 is stopped.

In other words, the CPU 11a performs control to cause the powder conveyance member 64 to be rotationally driven in a state where the rotation of the upstream cleaning member 62 is stopped.

As a result, as illustrated in FIG. 4, the rotation of the upstream cleaning member 62 is stopped, and the powder conveyance member 64 is rotationally driven. Note that in the state illustrated in FIG. 4, the intermediate transfer belt 41 is also stopped.

Here, a configuration in which the upstream cleaning member 62 and the powder conveyance member 64 operate in conjunction with each other is assumed.

In a configuration in which the upstream cleaning member 62 and the powder conveyance member 64 operate in conjunction with each other, when the rotation of the upstream cleaning member 62 is stopped, the rotation of the powder conveyance member 64 is also stopped. In this case, the conveyance of powder by the powder conveyance member 64 is also stopped.

In contrast, in the present exemplary embodiment, as described above, the CPU 11a performs control to cause the conveyance of powder by the powder conveyance member 64 to be performed in a state where the rotation of the upstream cleaning member 62 is stopped.

In this case, in a state where the movement of the upstream cleaning member 62 is stopped, powder in the powder accommodating section 45A is sequentially conveyed to the powder accommodating container positioned outside the powder accommodating section 45A.

When the powder in the powder accommodating section 45A is conveyed to the powder accommodating container in a state where the movement of the upstream cleaning member 62 is stopped, the powder in the powder accommodating section 45A gradually decreases.

In the present exemplary embodiment, the intermediate transfer belt 41 stops in response to the end of image forming processing or the like. Furthermore, in the present exemplary embodiment, the upstream cleaning member 62 stops in response to the stop of the intermediate transfer belt 41.

In the present exemplary embodiment, in order to prevent the outer peripheral surface 41A of the intermediate transfer belt 41 from being damaged by the rotating upstream cleaning member 62, the upstream cleaning member 62 is also stopped in response to the stop of the intermediate transfer belt 41.

In the present exemplary embodiment, as illustrated in FIG. 4, even in a state where the intermediate transfer belt 41 and the upstream cleaning member 62 are stopped, the powder conveyance member 64 operates and conveyance of powder is performed.

In the present exemplary embodiment, the CPU 11a performs control to cause the conveyance of powder by the powder conveyance member 64 to be performed in a state where the intermediate transfer belt 41 is stopped and the upstream cleaning member 62 is stopped.

In this case, the powder conveyance member 64 rotates in a state where no new powder is supplied from the intermediate transfer belt 41 into the powder accommodating section 45A. As a result, powder in the powder accommodating section 45A gradually decreases.

When processing of forming a toner image on the intermediate transfer belt 41 is performed, the CPU 11a performs control to cause the upstream cleaning member 62 to operate and performs control to convey powder by the powder conveyance member 64.

In other words, in an image forming mode in which the formation of the toner image on the intermediate transfer belt 41 is performed, the CPU 11a performs control to cause the upstream cleaning member 62 to operate and performs control to convey powder by the powder conveyance member 64.

Thus, cleaning of a portion of the intermediate transfer belt 41 reaching the belt cleaner 45 is sequentially performed, and powder generated by the cleaning is conveyed by the powder conveyance member 64.

For example, when the intermediate transfer belt 41 stops, the CPU 11a changes the mode of the image forming apparatus 1 to a discharge promoting mode.

When the intermediate transfer belt 41 stops, the CPU 11a stops the upstream cleaning member 62.

When the intermediate transfer belt 41 stops, the CPU 11a performs control to operate the powder conveyance member 64, regarding the powder conveyance member 64. In other words, the CPU 11a performs control such that the powder conveyance member 64 continues to operate even after the intermediate transfer belt 41 stops.

Accordingly, in a state where new powder is not supplied from the intermediate transfer belt 41 into the powder accommodating section 45A, the powder conveyance member 64 rotates, and powder is conveyed by the powder conveyance member 64.

As a result, discharge of powder from the powder accommodating section 45A to the outside of the powder accommodating section 45A is promoted.

Note that in the control of the powder conveyance member 64 in the discharge promoting mode, the powder conveyance member 64 may be temporarily stopped in accordance with the stop of the intermediate transfer belt 41, and then the operation of the powder conveyance member 64 may be resumed.

In addition, even when the intermediate transfer belt 41 is stopped, the powder conveyance member 64 may continue to operate instead of stopping, such that the operation of the powder conveyance member 64 is continued.

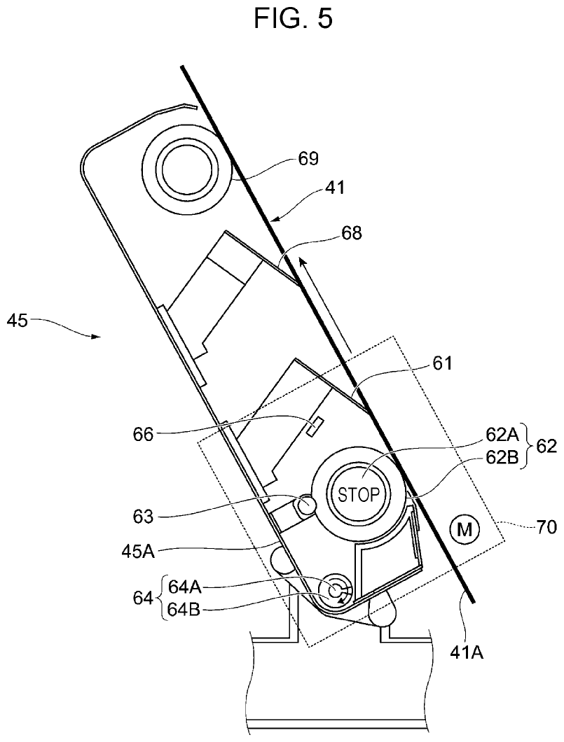

FIG. 5 is a diagram illustrating another state of the belt cleaner 45.

As another processing, as illustrated in FIG. 5, control may be performed, in a state where the intermediate transfer belt 41 is moving, to stop the upstream cleaning member 62 and to operate the powder conveyance member 64.

In a case where the upstream cleaning member 62 is stopped in a state where the intermediate transfer belt 41 is moving, the amount of powder newly supplied from the intermediate transfer belt 41 into the powder accommodating section 45A decreases because the upstream cleaning member 62 is stopped.

In this case, compared to a case where the upstream cleaning member 62 operates, the discharge of powder from the powder accommodating section 45A to the outside of the powder accommodating section 45A is promoted.

As in the present exemplary embodiment, when the conveyance of powder by the powder conveyance member 64 is performed in a state where at least the upstream cleaning member 62 of the upstream cleaning member 62 and the intermediate transfer belt 41 is stopped, the discharge of powder from the powder accommodating section 45A is promoted.

As a result, a problem caused by an increase in the amount of powder accommodated in the powder accommodating section 45A is less likely to occur.

When the amount of powder in the powder accommodating section 45A increases, the load acting on the powder conveyance member 64 increases, which may cause damage to the powder conveyance member 64 or a decrease in the performance of the belt cleaner 45 to clean the intermediate transfer belt 41.

In contrast, when conveyance of powder by the powder conveyance member 64 is performed in a state where at least the upstream cleaning member 62 is stopped, discharge of powder from the powder accommodating section 45A is promoted. In this case, the above-described problem caused by the increase in the amount of powder accommodated in the powder accommodating section 45A is less likely to occur.

### Description of Drive Mechanism 70

In the present exemplary embodiment, as illustrated in FIG. 3, the drive mechanism 70 that drives the upstream cleaning member 62 and the powder conveyance member 64 is provided.

The drive mechanism 70 is provided with one motor M, and in the present exemplary embodiment, the upstream cleaning member 62 and the powder conveyance member 64 are driven by the one common motor M.

In the present exemplary embodiment, when the motor M rotates in one direction, the upstream cleaning member 62 and the powder conveyance member 64 are driven. More specifically, when a rotor inside the motor M rotates in one direction, the upstream cleaning member 62 and the powder conveyance member 64 are driven.

Further, in the present exemplary embodiment, when the motor M rotates in an opposite direction, the upstream cleaning member 62 stops and the powder conveyance member 64 is driven. More specifically, when the rotor inside the motor M rotates in the opposite direction, the upstream cleaning member 62 stops and the powder conveyance member 64 is driven.

In the present exemplary embodiment, the CPU 11a controls the motor M to rotate in the opposite direction to perform the above-described control for causing the powder conveyance member 64 to convey powder in a state where the movement of the upstream cleaning member 62 is stopped.

In the present exemplary embodiment, the CPU 11a rotates the motor M in one direction in the image forming mode in which formation of a toner image on the intermediate transfer belt 41 is performed.

In the discharge promoting mode in which the discharge of powder toner from the powder accommodating section 45A is promoted, the CPU 11a rotates the motor M in the opposite direction.

The drive mechanism 70 will be described in detail.

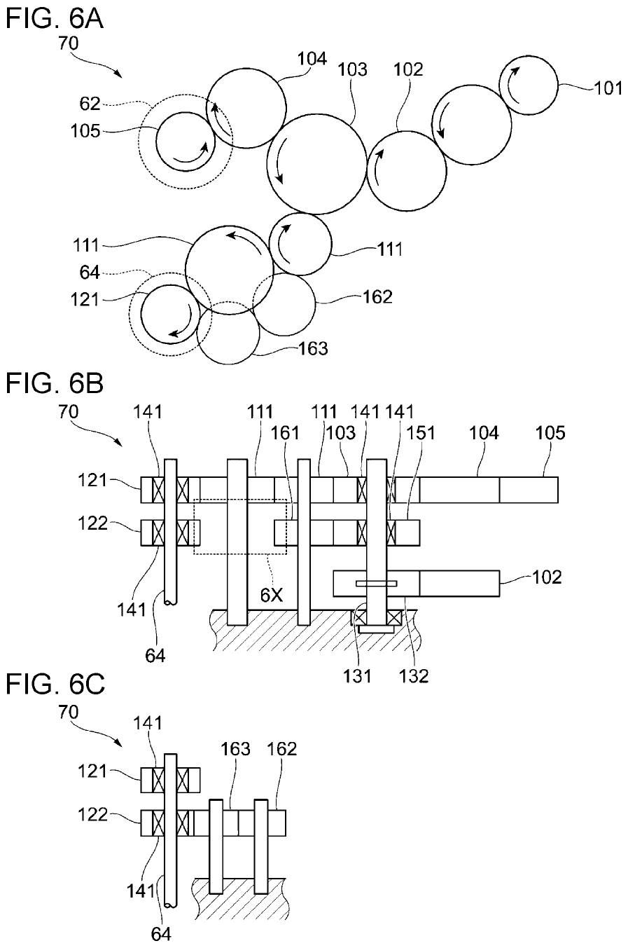

FIGS. 6A to 6C are diagrams illustrating the configuration of the drive mechanism 70.

As illustrated in FIG. 6A, the drive mechanism 70 of the present exemplary embodiment is provided with a motor gear 101 that rotates by receiving a driving force from the motor M (see FIG. 3). The drive mechanism 70 is further provided with a driving force input gear 102 that rotates by receiving a driving force from the motor gear 101.

The drive mechanism 70 is further provided with a branch gear 103 that rotates by receiving a driving force from the driving force input gear 102. In the present exemplary embodiment, the driving force is transmitted from the branch gear 103 to each of the upstream cleaning member 62 and the powder conveyance member 64.

A cleaning side interlocking gear 105 is coupled to the branch gear 103 via a cleaning side transmission gear 104.

In the present exemplary embodiment, in the case where the motor M rotates in one direction, the driving force is transmitted from the branch gear 103 to the cleaning side interlocking gear 105, such that the upstream cleaning member 62 disposed coaxially with the cleaning side interlocking gear 105 is driven.

In the present exemplary embodiment, when the driving force is transmitted from the branch gear 103 to the cleaning side interlocking gear 105 and the cleaning side interlocking gear 105 rotates, the upstream cleaning member 62 rotates.

Further, in the present exemplary embodiment, as illustrated in FIG. 6A, a first conveyance side interlocking gear 121 is coupled to the branch gear 103 via two conveyance side transmission gears 111.

In the present exemplary embodiment, when the motor M rotates in one direction, the driving force is transmitted from the branch gear 103 to the first conveyance side interlocking gear 121 via the two conveyance side transmission gears 111.

As a result, the powder conveyance member 64 disposed coaxially with the first conveyance side interlocking gear 121 is driven.

FIG. 6B is a diagram illustrating a cross-sectional structure of the drive mechanism 70 when the drive mechanism 70 illustrated in FIG. 6A is viewed from the side.

Note that FIGS. 6A to 6C are diagrams for explaining transmission paths of force, and arrangement positions of the respective gears are different from actual arrangement positions in FIGS. 6A to 6C.

In the present exemplary embodiment, as illustrated in FIG. 6B, the branch gear 103 is supported by a rotation shaft 131. A receiving gear 132 that receives a driving force from the driving force input gear 102 is attached to the rotation shaft 131.

In the present exemplary embodiment, the receiving gear 132 rotates in association with the rotation of the driving force input gear 102, and the rotation shaft 131 and the branch gear 103 rotate correspondingly. When the branch gear 103 rotates, as described above, the upstream cleaning member 62 and the powder conveyance member 64 rotate.

A one-way clutch 141 is provided between the branch gear 103 and the rotation shaft 131. In the present exemplary embodiment, when the motor M rotates in one direction, the branch gear 103 rotates in conjunction with the rotation shaft 131.

Accordingly, when the motor M rotates in one direction, the driving force is transmitted from the branch gear 103 to each of the cleaning side interlocking gear 105 and the first conveyance side interlocking gear 121, and the upstream cleaning member 62 and the powder conveyance member 64 are driven.

On the other hand, when the motor M rotates in a reverse direction, the branch gear 103 is not interlocked with the rotation shaft 131.

In this case, no driving force is transmitted to each of the cleaning side interlocking gear 105 and the first conveyance side interlocking gear 121, such that the upstream cleaning member 62 and the powder conveyance member 64 are not driven.

When the motor M rotates in the reverse direction, a driving force is transmitted to the powder conveyance member 64 via another transmission path.

In the present exemplary embodiment, as illustrated in FIG. 6B, in addition to the branch gear 103, a powder conveyance gear 151 is attached to the rotation shaft 131.

The one-way clutch 141 is provided between the powder conveyance gear 151 and the rotation shaft 131.

In the present exemplary embodiment, a configuration is adopted in which, when the motor M rotates in one direction, no driving force is transmitted from the rotation shaft 131 to the powder conveyance gear 151. In the present exemplary embodiment, when the motor M rotates in the reverse direction, a driving force is transmitted from the rotation shaft 131 to the powder conveyance gear 151.

As illustrated in FIG. 6B, the powder conveyance gear 151 is provided with a first meshing gear 161 that meshes with the powder conveyance gear 151.

The first meshing gear 161 is disposed coaxially with the conveyance side transmission gear 111 positioned next to the branch gear 103.

Furthermore, in the present exemplary embodiment, as illustrated in FIGS. 6A and 6C, a second meshing gear 162 and a third meshing gear 163 that mesh with the first meshing gear 161 are provided.

The second meshing gear 162 and the third meshing gear 163 illustrated in FIG. 6C are provided at a portion indicated by a reference numeral 6X in FIG. 6B.

As illustrated in FIG. 6C, the third meshing gear 163 meshes with a second conveyance side interlocking gear 122 that interlocks with the powder conveyance member 64.

The second conveyance side interlocking gear 122 is disposed coaxially with the powder conveyance member 64, and is disposed coaxially with the first conveyance side interlocking gear 121.

In the present exemplary embodiment, when the motor M rotates in a reverse direction, a driving force is transmitted to the powder conveyance member 64 via the rotation shaft 131 (see FIG. 6B), the powder conveyance gear 151, the first meshing gear 161, the second meshing gear 162 (see FIGS. 6A and 6C), the third meshing gear 163, and the second conveyance side interlocking gear 122. Thus, the powder conveyance member 64 is driven.

In the present exemplary embodiment, regardless of whether the motor M rotates in one direction or in the opposite direction, the powder conveyance member 64 rotates in one direction which is a common direction.

In the present exemplary embodiment, the number of gears provided between the branch gear 103 and the first conveyance side interlocking gear 121 is an even number. The number of gears provided between the powder conveyance gear 151 and the second conveyance side interlocking gear 122 is an odd number.

In this case, regardless of whether the motor M rotates in one direction or in the opposite direction, the powder conveyance member 64 rotates in one direction which is a common direction.

Specifically, as illustrated in FIG. 6B, two conveyance side transmission gears 111 are provided between the branch gear 103 and the first conveyance side interlocking gear 121, and the even number of gears are provided between the branch gear 103 and the first conveyance side interlocking gear 121.

As illustrated in FIGS. 6B and 6C, three gears of the first meshing gear 161 to the third meshing gear 163 are provided between the powder conveyance gear 151 and the second conveyance side interlocking gear 122, and the odd number of gears are provided between the powder conveyance gear 151 and the second conveyance side interlocking gear 122.

In this case, regardless of whether the motor M rotates in one direction or in the opposite direction, the powder conveyance member 64 rotates in one direction which is a common direction.

Further, in the present exemplary embodiment, as illustrated in FIGS. 6B and 6C, the one-way clutch 141 is provided between the powder conveyance member 64 and the first conveyance side interlocking gear 121 and between the powder conveyance member 64 and the second conveyance side interlocking gear 122.

Here, a case is assumed in which one of the first conveyance side interlocking gear 121 and the second conveyance side interlocking gear 122 rotates to rotate the powder conveyance member 64.

In this case, no driving force is transmitted from the rotating powder conveyance member 64 to the other conveyance side interlocking gear in the present exemplary embodiment.

### Timing of Processing

The above-described processing of operating the powder conveyance member 64 after stopping at least the upstream cleaning member 62 (hereinafter, referred to as “powder conveyance processing”) is performed, for example, in response to the end of the image forming processing.

In other words, the switching from the image forming mode to the discharge promoting mode is performed in response to the end of the image forming processing.

In addition, the powder conveyance processing may be performed at another timing. The powder conveyance processing may be performed not only when the condition of ending the image forming processing is satisfied but also when another condition is satisfied.

Specifically, the powder conveyance processing may be performed, for example, when the amount of powder accommodated in the powder accommodating section 45A (see FIG. 3) exceeds a predetermined amount.

When the amount of powder accommodated in the powder accommodating section 45A exceeds a predetermined amount, the CPU 11a stops the intermediate transfer belt 41 and stops the upstream cleaning member 62, and causes conveyance of powder to be performed by the powder conveyance member 64, regarding the powder conveyance member 64.

In the present exemplary embodiment, when the output from the amount detection sensor 66 (see FIG. 3) indicates that the amount of powder exceeds a predetermined amount, the CPU 11a performs control to stop the intermediate transfer belt 41 and stop the upstream cleaning member 62.

At this time, the CPU 11a performs control to cause the conveyance of powder by the powder conveyance member 64 to be continuously performed.

Note that as described above, the processing of stopping the movement of the upstream cleaning member 62 may be performed while operating the intermediate transfer belt 41 and the powder conveyance member 64.

In addition, the powder conveyance processing may be performed based on amount information which is information about an amount of toner which is a material configuring a toner image held by the intermediate transfer belt 41.

When this processing is performed, the CPU 11a acquires the amount information that is information about the amount of toner configuring the toner image held by the intermediate transfer belt 41.

Specifically, in this case, every time a toner image is formed, the CPU 11a analyzes image data that is the source of the toner image and acquires information about density of the toner image.

Then, the CPU 11a acquires the amount information that is the information about the amount of toner configuring the toner image held by the intermediate transfer belt 41, based on the acquired information on the density. In other words, the CPU 11a acquires the amount information that is the information about the amount of toner that is a material configuring the toner image placed on the intermediate transfer belt 41.

Then, the CPU 11a adds the acquired amount information and each piece of the amount information acquired so far, which is stored in an information storage section such as the secondary storage section 91, to acquire a total sum of the amount information.

In the present exemplary embodiment, every time the CPU 11a acquires new amount information, the CPU 11a stores the acquired amount information in the information storage section. As a result, each piece of the amount information obtained so far by the CPU 11a is stored in the information storage section.

When new amount information is acquired in association with formation of a new toner image, the CPU 11a adds the acquired amount information to the pieces of the amount information acquired so far, which is stored in the information storage section, and acquires the total sum of the amount information.

Then, the CPU 11a determines whether the total sum exceeds a predetermined threshold.

Then, when the CPU 11a determines that the total sum exceeds the predetermined threshold, the CPU 11a sets the mode of the image forming apparatus 1 to the discharge promoting mode described above.

Accordingly, powder is conveyed by the powder conveyance member 64 in a state where at least the upstream cleaning member 62 is stopped.

When the total sum of the amount information exceeds the predetermined threshold, it is assumed that a large amount of powder is accommodated in the powder accommodating section 45A.

In this case, as in the present exemplary embodiment, when the discharge promoting mode is set, the discharge of powder from the powder accommodating section 45A is promoted.

Note that in the present exemplary embodiment, when the mode of the image forming apparatus 1 is set to the discharge promoting mode, the information about each piece of the amount information described above stored in the information storage section is deleted, and the information storage section is reset.

### Other Configurations

In addition, a drive source that drives the upstream cleaning member 62 and a drive source that drives the powder conveyance member 64 may be separately provided.

In the above description, a case where the upstream cleaning member 62 and the powder conveyance member 64 are driven by one common motor M has been described, but the present disclosure is not limited thereto, and each of the upstream cleaning member 62 and the powder conveyance member 64 may be configured to be driven by different motors.

In the case where the upstream cleaning member 62 and the powder conveyance member 64 are driven by different motors respectively, not only the processing of completely stopping the upstream cleaning member 62 but also the processing of reducing the output of the upstream cleaning member 62 can be performed. In other words, the processing of reducing the number of rotations can be performed while maintaining the rotation of the upstream cleaning member 62.

Although description is omitted above, in the present exemplary embodiment, as illustrated in FIG. 1, a belt motor BM that drives the intermediate transfer belt 41 is provided.

In the present exemplary embodiment, by reducing the output of the belt motor BM, the output of the intermediate transfer belt 41 can also be reduced. In other words, a moving speed of the intermediate transfer belt 41 can also be reduced.

As illustrated in FIG. 1, a driving roll 41R that is driven by the belt motor BM and applies a driving force to the intermediate transfer belt 41 is provided inside the intermediate transfer belt 41. When the output of the belt motor BM is reduced, the number of rotations of the driving roll 41R is reduced, and the moving speed of the intermediate transfer belt 41 is reduced.

Although the case where the powder conveyance member 64 is driven with the intermediate transfer belt 41 and the upstream cleaning member 62 stopped or with only the upstream cleaning member 62 stopped has been described above, a manner of driving the intermediate transfer belt 41, the upstream cleaning member 62, and the powder conveyance member 64 is not limited thereto.

For example, the CPU 11a may perform control to cause the conveyance of powder by the powder conveyance member 64 to be performed in a state where the intermediate transfer belt 41 is being moved and in a state where the output of the upstream cleaning member 62 is reduced.

In other words, the CPU 11a may perform control to cause the conveyance of powder by the powder conveyance member 64 to be performed in a state where the intermediate transfer belt 41 is being moved and in a state where the number of rotations of the upstream cleaning member 62 is reduced.

Also in this case, the amount of powder removed from the intermediate transfer belt 41 decreases, and the amount of powder newly supplied into the powder accommodating section 45A decreases. On the other hand, the conveyance of powder by the powder conveyance member 64 is continued.

In this case, compared to a case where the output of the upstream cleaning member 62 is not reduced, the discharge of powder from the inside of the powder accommodating section 45A is promoted.

In addition, the CPU 11a may perform control to cause the conveyance of powder by the powder conveyance member 64 to be performed in a state where the intermediate transfer belt 41 is stopped and in a state where the output of the upstream cleaning member 62 is reduced.

Alternatively, the CPU 11a may perform control to cause the conveyance of powder by the powder conveyance member 64 to be performed in a state where the moving speed of the intermediate transfer belt 41 is reduced and in a state where the upstream cleaning member 62 is stopped.

In addition, the CPU 11a may perform control to cause the conveyance of powder by the powder conveyance member 64 to be performed in a state where the moving speed of the intermediate transfer belt 41 is reduced and in a state where the output of the upstream cleaning member 62 is reduced.

Furthermore, although the upstream cleaning member 62 that moves in contact with the intermediate transfer belt 41 has been mainly described above, it is also assumed that the belt cleaner 45 is not provided with a cleaning member that moves in contact with the intermediate transfer belt 41.

Specifically, a configuration in which only a cleaning member in a stationary state such as the downstream cleaning member 61 (see FIG. 3) is provided in the belt cleaner 45 is also assumed.

In the case of this configuration, the CPU 11a performs control to cause the conveyance of powder by the powder conveyance member 64 to be performed in a state where the intermediate transfer belt 41 is stopped or in a state where the moving speed of the intermediate transfer belt 41 is reduced.

In this case, the conveyance of powder by the powder conveyance member 64 is performed in a state where the intermediate transfer belt 41 is stopped, or the conveyance of powder by the powder conveyance member 64 is performed in a state where the moving speed of the intermediate transfer belt 41 is reduced.

Also in this case, the amount of powder newly supplied into the powder accommodating section 45A decreases, and the discharge of powder from the powder accommodating section 45A is promoted.

### Others

Although the configuration and processing for cleaning the intermediate transfer belt 41 as an example of the image holding member have been described above, the configuration and processing described above according to the present exemplary embodiment may be used for cleaning the photoreceptor drum 31 as another example of the image holding member.

When cleaning the photoreceptor drum 31, in a case where the above-described configuration is adopted and the above-described processing is performed, the discharge of powder in the drum cleaner 34 (see FIG. 1) is promoted.

Another example of the condition for switching the mode of the image forming apparatus 1 to the discharge promoting mode is that the state specified by environment information has become a predetermined specific state. For example, when the state specified by the environmental information is high temperature and high humidity, the processing of switching to the discharge promoting mode may be performed.

Further, for example, an operation time of the image forming apparatus 1, a number of sheets P on which images have been formed, and the like may be counted, and when the operation time or the number of sheets exceeds a predetermined threshold, the processing of switching to the discharge promoting mode may be performed.

### APPENDIX

(((1)))

An image forming apparatus comprising:
an image holding member that moves while holding an image to be transferred to a recording medium;
a cleaning member that moves in contact with the image holding member to clean the image holding member;
a conveyance member that conveys powder removed from the image holding member by the cleaning member; and
a processor configured to perform control to cause conveyance of powder by the powder conveyance member to be performed in a state where the cleaning member is stopped or in a state where an output of the cleaning member is reduced.
(((2)))

The image forming apparatus according to (((1))), wherein the processor performs control to cause the conveyance of power by the power conveyance member to be performed in a state where the cleaning member is stopped or the output of the cleaning member is reduced and in a state where the image holding member is stopped or a moving speed of the image holding member is reduced.
(((3))

The image forming apparatus according to (((1))), wherein when processing of forming an image on the moving image holding member is performed, the processor performs control to cause the cleaning member to operate and performs control to cause the conveyance of power by the power conveyance member to be performed.
(((4)))

The image forming apparatus according to (((3))), wherein when the image holding member stops, the processor performs control to stop the cleaning member and to cause the conveyance member to operate, regarding the conveyance member.
(((5)))

The image forming apparatus according to (((1))), wherein
the conveyance member is provided in an accommodating section that accommodates powder removed from the image holding member by the cleaning member, and
when an amount of powder accommodated in the accommodating section exceeds a predetermined amount, the processor performs control to stop the moving image holding member or decrease a moving speed of the moving image holding member and stop the cleaning member or decrease the output of the cleaning member, and to cause the conveyance of powder by the conveyance member to be performed, regarding the conveyance member.
(((6)))

The image forming apparatus according to (((5))), wherein when the amount of powder accommodated in the accommodating section exceeds the predetermined amount, the processor performs control to stop the image holding member and the cleaning member, and performs control to cause the conveyance of powder by the conveyance member to be performed, regarding the conveyance member.
(((7)))

The image forming apparatus according to (((1))), wherein the processor
acquires amount information that is information about an amount of a material configuring the image held by the image holding member, and
when an amount specified by the amount information is larger than a predetermined threshold, the processor performs control to stop the moving image holding member or decrease a moving speed of the moving image holding member and stop the cleaning member or decrease the output of the cleaning member, and to cause the conveyance of powder by the conveyance member to be performed, regarding the conveyance member.
(((8)))

The image forming apparatus according to (((7))), wherein when the amount specified by the amount information is larger than the predetermined threshold, the processor performs control to stop the image holding member and the cleaning member, and to cause the conveyance of powder by the conveyance member to be performed, regarding the conveyance member.
(((9)))

The image forming apparatus according to (((1))), wherein the image forming apparatus is configured such that when a motor rotates in one direction, the cleaning member moves and the conveyance member operates, and when the motor rotates in an opposite direction, the cleaning member stops and the conveyance member operates, and the processor performs control to rotate the motor in the opposite direction and performs the control to cause the conveyance of powder by the conveyance member to be performed in a state where the cleaning member stops moving.
(((10)))

An image forming apparatus comprising:
an image holding member that moves while holding an image to be transferred to a recording medium;
a cleaning member that cleans the image holding member;
a conveyance member that conveys powder removed from the image holding member by the cleaning member; and
a processor configured to perform control to cause conveyance of powder by the conveyance member to be performed in a state where the image holding member is stopped or in a state where a moving speed of the image holding member is reduced.

What is claimed is:

1. An image forming apparatus comprising:
an image holding member that moves while holding an image to be transferred to a recording medium;
a cleaning member that moves in contact with the image holding member to clean the image holding member;
a conveyance member that conveys powder removed from the image holding member by the cleaning member; and
a processor configured to perform control to cause conveyance of powder by the powder conveyance member to be performed in a state where the cleaning member is stopped or in a state where an output of the cleaning member is reduced.

2. The image forming apparatus according to claim 1, wherein
the processor performs control to cause the conveyance of power by the conveyance member to be performed in a state where the cleaning member is stopped or the output of the cleaning member is reduced and in a state where the image holding member is stopped or a moving speed of the image holding member is reduced.

3. The image forming apparatus according to claim 1, wherein
when processing of forming an image on the moving image holding member is performed, the processor performs control to cause the cleaning member to operate and performs control to cause the conveyance of powder by the conveyance member to be performed.

4. The image forming apparatus according to claim 3, wherein
when the image holding member stops, the processor performs control to stop the cleaning member and to cause the conveyance member to operate, regarding the conveyance member.

5. The image forming apparatus according to claim 1, wherein
the conveyance member is provided in an accommodating section that accommodates powder removed from the image holding member by the cleaning member, and
when an amount of powder accommodated in the accommodating section exceeds a predetermined amount, the processor performs control to stop the moving image holding member or decrease a moving speed of the moving image holding member and stop the cleaning member or decrease the output of the cleaning member, and to cause the conveyance of powder by the conveyance member to be performed, regarding the conveyance member.

6. The image forming apparatus according to claim 5, wherein
when the amount of powder accommodated in the accommodating section exceeds the predetermined amount, the processor performs control to stop the image holding member and the cleaning member, and performs control to cause the conveyance of powder by the conveyance member to be performed, regarding the conveyance member.

7. The image forming apparatus according to claim 1, wherein the processor
acquires amount information that is information about an amount of a material configuring the image held by the image holding member, and
when an amount specified by the amount information is larger than a predetermined threshold, the processor performs control to stop the moving image holding member or decrease a moving speed of the moving image holding member and stop the cleaning member or decrease the output of the cleaning member, and to cause the conveyance of powder by the conveyance member to be performed, regarding the conveyance member.

8. The image forming apparatus according to claim 7, wherein
when the amount specified by the amount information is larger than the predetermined threshold, the processor performs control to stop the image holding member and the cleaning member, and to cause the conveyance of powder by the conveyance member to be performed, regarding the conveyance member.

9. The image forming apparatus according to claim 1, wherein
the image forming apparatus is configured such that when a motor rotates in one direction, the cleaning member moves and the conveyance member operates, and when the motor rotates in an opposite direction, the cleaning member stops and the conveyance member operates, and
the processor performs control to rotate the motor in the opposite direction and performs the control to cause the conveyance of powder by the conveyance member to be performed in a state where the cleaning member stops moving.

10. An image forming apparatus comprising:
an image holding member that moves while holding an image to be transferred to a recording medium;
a cleaning member that cleans the image holding member;
a conveyance member that conveys powder removed from the image holding member by the cleaning member; and
a processor configured to perform control to cause conveyance of powder by the conveyance member to be performed in a state where the image holding member is stopped or in a state where a moving speed of the image holding member is reduced.
